(19) United States
(12) Patent Application Publication
(10) Pub. No.: US 2017/0071016 A1
(43) Pub. Date: Mar. 9, 2017

(54) METHOD FOR CREATING A MULTIPOINT-TO-POINT (MP2P) EPS BEARER IN TRANSMISSION NETWORK

(71) Applicant: TEJAS NETWORKS LIMITED, Bangalore (IN)

(72) Inventor: VINOD KUMAR MADAIAH, Bangalore (IN)

(21) Appl. No.: 15/256,567

(22) Filed: Sep. 3, 2016

(30) Foreign Application Priority Data
Sep. 4, 2015 (IN) 4680/CHE/2015

(51) Int. Cl. H04W 76/02; H04W 68/02

(52) U.S. Cl. CPC H04W 76/021; H04W 68/02; H04W 76/025; H04W 88/02

(57) ABSTRACT

A method and system for creating a Multipoint-to-Point (MP2P) EPS bearer in a packet switched transmission network is disclosed. The method includes acquiring the data from a plurality of User Equipments (301), and communicably coupling each of the User Equipments with a radio bearer (302) such that the data acquired by the User Equipments is transmitted to the radio bearer. The radio bearer is communicably coupled to an S1 bearer (303) that receives and multiplexes the data before transmitting it to an S5 bearer (304). The radio bearer, S1 bearer and S5 bearer in combination constitute the MP2P EPS bearer.

### CROSS REFERENCE TO RELATED APPLICATIONS

Benefit is claimed under 35 U.S.C. 119(a)-(d) to Foreign application Serial No. 4680/CHE/2015 filed in India entitled “A SYSTEM FOR PROVIDING ENHANCEMENTS TO SUPPORT NEW CLASSES OF USER EQUIPMENTS”, on Sep. 4, 2015, and the contents of which is incorporated in entirety as reference herein.

### BACKGROUND

Technical Field

The present disclosure is related to wireless communication systems. The present disclosure is more particularly related to communication between a plurality of low power User Equipments (UE) situated in a packet switched network.

Description of the Related Art

Wireless communication systems are widely used to provide voice and data services for multiple users using a variety of access terminals such as cellular telephones, laptop computers and various User Equipment (UE) devices. The communication system can use one or more multiple access techniques, such as Frequency Division Multiple Access (FDMA), Time Division Multiple Access (TDMA), Code Division Multiple Access (CDMA), Orthogonal Frequency Division Multiple Access (OFDMA), Single Carrier Frequency Division Multiple Access (SC-FDMA). Mobile broadband networks typically conform to a number of standards such as the main 2^{nd} Generation (2G) technology. Global System for Mobile Communications (GSM), the main 3^{rd} Generation (3G) technology, Universal Mobile Telecommunications System (UMTS) and the main 4th-Generation (4G) technology and Long Term Evolution (LTE).

In the universal mobile telecommunication system (UMTS) a User Equipment (UE) is a device directly used by an end-user for communication. The examples of the UE include, but are not limited to a hand-held telephone, a laptop computer equipped with a broadband adapter, a water meter, an electricity meter, and the like. The UE is configured to utilize a cellular connection such as Long Term Evolution (LTE) cellular connection, wireless local area network (WLAN) connection and the like for transmission of data.

The conventional UE communication systems are set up using Point-to-Point (P2P) EPS bearers for each Utility UE. Thus, the conventional systems consume surplus resources and require a plurality of core elements. Further, the conventional systems maintain the S5 bearer in an ‘ON’ state even when the UE does not have any data to transmit. In addition, the conventional systems do not consider low data size for transmission.

In view of the foregoing, there is felt a need for a system that provides enhancements for supporting low power UEs. Further there exists need for a system aiding in communication that is maintained in a ‘OFF’ state. Furthermore, there exists need for a system that automatically optimizes a network resource requirement, for collection of low data size messages from a plurality of low power User Equipments.

The above-mentioned shortcomings, disadvantages and problems are addressed herein and which will be understood by reading and studying the following specification.

### OBJECTS

The primary object of the present disclosure is to create a Multipoint-to-Point (MP2P) EPS bearer in a packet switched transmission network.

Another object of the present disclosure is to utilize low data size User Equipments (UE) or utility UEs to establish connection with other devices.

Yet another object of the present disclosure is to use multipoint to point (MP2P) EPS bearer setup at the utility UE to communicate the information between a plurality of User Equipments.

Yet another object of the present disclosure is to optimize the number of peer-to-peer or point to point (P2P) EPS bearers used in the communication system.

Yet another object of the present disclosure is to optimize a network resource requirement for collection of low data size messages from a plurality of User Equipments.

These and other objects and advantages of the embodiments herein will become readily apparent from the following detailed description taken in conjunction with the accompanying drawings.

### SUMMARY

In accordance with an embodiment of the present disclosure, a Multipoint-to-Point (MP2P) EPS bearer system in a packet switched transmission network is disclosed. The system includes a first User Equipment (UE-1), a second User Equipment (UE-2), a radio bearer, a mobile management entity (MME), and a S1 bearer for owner of all User Equipment, a S5 bearer for owner of all User Equipment, an ENB, a serving gateway, and a packet data network gateway.

In accordance with an embodiment of the present disclosure, a method for creating a Multipoint-to-Point (MP2P) EPS bearer in a packet switched transmission network includes installing a plurality of User Equipment's (UE) at predetermined destinations to acquire data there from. The User Equipments are communicably coupled to respective radio bearers. Each radio bearer is configured to receive the data acquired by the User Equipments. The method further includes communicably coupling each of said radio bearers to at least one S1 bearer, and communicably coupling the S1 bearer to an S5 bearer. The S1 bearer is configured to multiplex the data received from each of the radio bearers and the S5 bearer is configured to receive the multiplexed data from the S1 bearer. The received data is further transmitted to a database server via a public network gateway. The Multipoint-to-Point EPS bearer is created by a communicable coupling between said radio bearers, the S1 bearer and the S5 bearer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may he made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating a prior art UE setup;

FIG. 2 illustrates a block diagram of a Multipoint-to-Point (MP2P) EPS bearer system, according to one embodiment of the present disclosure.

FIG. 3 is a flowchart illustrating a method for creating a Multipoint-to-Point (MP2P) EPS bearer in a packet switched transmission network, according to one embodiment of the present invention.

Although the specific features of the present disclosure are shown in some drawings and not in others, this is done for convenience only as each feature may be combined with any or all of the other features in accordance with the present disclosure.

### DETAILED DESCRIPTION

In the following detailed description, a reference is made to the accompanying drawings that form a part hereof, and in which the specific embodiments that may be practiced are shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

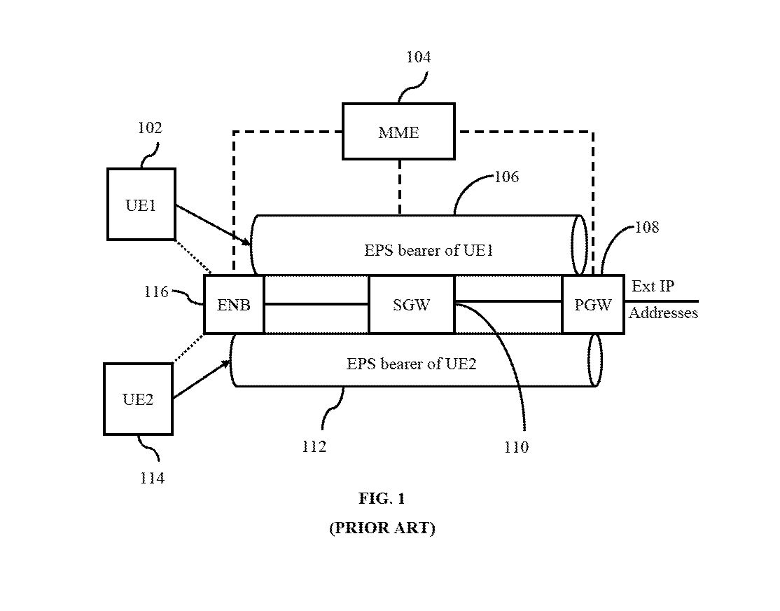

FIG. 1 illustrates a block diagram of a prior art communication network. The communication network includes a first User Equipment (UE1) 102, a second User Equipment (UE2) 114, a mobile management entity (MME) 104, an EPS bearer 106 for UE1, an EPS bearer 112 for UE2, a packet data network gateway (PGW) 108, a serving gateway (SGW) 110, and an eNodeB (Evolved Node B) 116. The eNodeB 116 enables direct wireless communication with between the UE1 and UE2.

As shown in FIG. 1, both User Equipments, i.e. UE1 and UE2 are setup with an individual end-to-end EPS bearer (106 and 112 respectively) to transmit data. The UE-1 102 is communicably coupled to the EPS bearer system 106, and the UE-2 114 is communicably coupled to the EPS bearer system 112. In order to transmit data to an external device, each of the User Equipments (UE1 and UE2) use individual bearer systems, i.e. EPS bearer 106 and EPS bearer 112 respectively.

As is evident from the prior art communication network, the end-to-end EPS bearers (106 and 112) are always initiated by respective UEs (UE1 and UE2) for both mobile originating calls and mobile terminating calls.

The various embodiments of the present disclosure provide a system for providing enhancements to support a new class of User Equipment (UE) including machine-to-machine and Internet-of-things (IoT) devices.

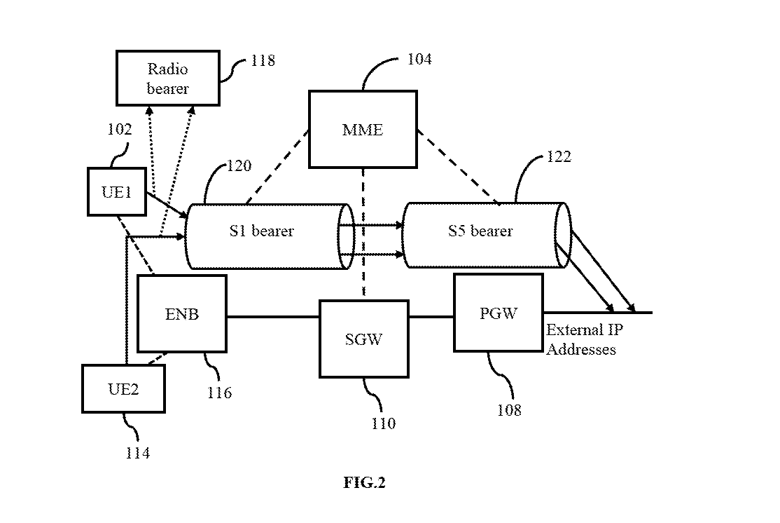

FIG. 2 illustrates a block diagram of a Multipoint-to-Point (MP2P) EPS bearer system, according to one embodiment of the present disclosure. The Multipoint-to-Point (MP2P) EPS bearer system, in accordance with the present disclosure includes a first User Equipment (UE1) 102, a second User Equipment (UE2) 114, a radio bearer 118 (typically, radio bearer are channels for transfer of either user or control data), a mobile management entity (MME) 104, a S1 bearer 120 in communication with UE1 102 and UE2 114, a S5 bearer 122, a ENB 116, a serving gateway (SGW) 110, and a packet data network gateway (PGW) 108.

In accordance with the present disclosure, the examples of the first utility equipment 102 and the second utility equipment 114 include, but are not limited to a mobile station, an electricity meter, and a water meter.

The multipoint-to-point (MP2P) EPS bearer includes an S1 bearer 120 communicating with every eNodeB (Evolved Node B or ENB) within the tracking area (TA) of the serving gateway 110. The S1 bearer 120 is communicably coupled to an S5 bearer 122. The MME 104 initiates set up of multipoint-to-point (MP2P) EPS bearer in a plurality of ways, including initiating the setup of MP2P EPS bearer is via the MME 104 or via special User Equipment that requests the standard MME 104 for such a setup.

In accordance with the present disclosure, the MP2P EPS bearer system renders the MP2P EPS bearer setup independent of the paging message, and decouples the phases of setting up the MP2P bearer and transmitting a paging message, in contrary to the prior art schemes in which the setup of an EPS bearer always followed the phase of transmission of the paging message to the relevant User Equipments.

In accordance with the present disclosure, upon completion of the MP2P EPS bearer setup, a paging message is transmitted to all the User Equipments within a predetermined tracking area, and in this case UE1 102 and UE2 114 in order to trigger the User Equipments, to transmit the (acquired) data, either simultaneously or one after the other. Following the receipt of the paging messages, the User Equipments 102 and 114 initiate transmission of the data via the radio bearer 118.

In accordance with the present disclosure, the data from a plurality of User Equipments from a single ENB is multiplexed by S1 bearer 120. Further, the data from a plurality of S1 bearer 120 is transmitted to the S5 bearer 122 multiplexed within the S5 bearer 122. Consequently, the data from the User Equipments 102 and 114 is forwarded to a pre-designated data storage by a packet network gateway 108.

In accordance with the present disclosure, the paging message and the setup of the EPS Bearer are decoupled. The MP2P EPS bearer is setup only when meter readings are to be acquired from the User Equipments. Further, once the data is acquired from the User Equipments, the associated MP2P EPS bearer is turned dormant (inactive). Further, the MP2P system also accommodates to data size User Equipments which are also known as utility User Equipments. The MP2P EPS bearer system optimizes the existing P2P EPS bearer system, by collecting lower sized data from a plurality of utility User Equipments, and further ensuring that the quantum of network resource elements utilized for such lower sized data elements is also optimized.

In an exemplary embodiment of the present disclosure, the size of unique data or information transmitted by a User Equipment is 40 bits per month.

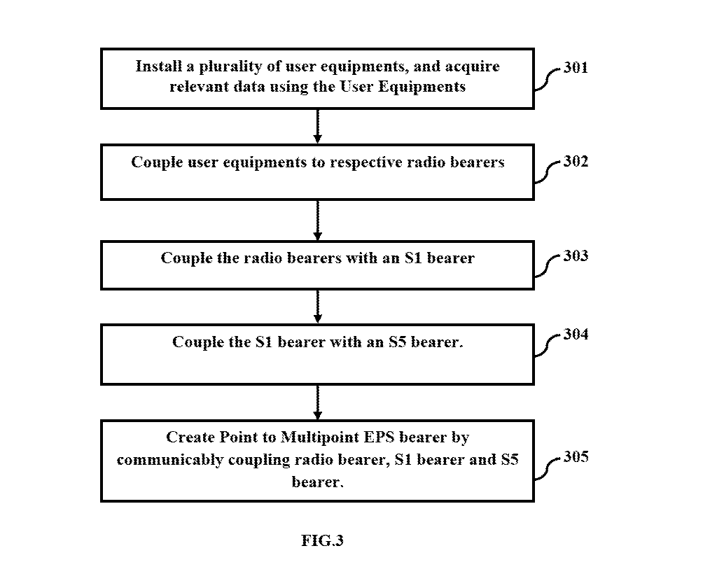

FIG. 3 is a flowchart illustrating a method for creating a Multipoint-to-Point (MP2P) EPS bearer in a packet switched transmission network, in accordance with the present disclosure. The method envisaged by the present disclosure includes installing a plurality of User Equipments (UE) are installed at predetermined destinations to acquire data there from (301). The User Equipment is communicably coupled to respective radio bearers (302). Each radio bearer is configured to receive the data collected by the User Equipments. Further, said radio bearer is communicably coupled to at least one S1 bearer (303). The S1 bearer is communicably coupled to an S5 bearer (304). The S1 bearer is configured to multiplex the data received from each of the radio bearers and transmit the multiplexed data to an S5 bearer. The multiplexed data is further transmitted from the S5 bearer to a database server via a public network gateway. The Multipoint-to-Point EPS bearer is created by a communicable coupling between said radio bearers, the S1 bearer and the S5 bearer (305).

In accordance with the present disclosure, the Multipoint-to-Point EPS bearer is configured using an MME (Mobility Management Entity) protocol. The Multipoint-to-Point (MP2P) EPS bearer could also be created using a customized User Equipment. A paging message is created and transmitted to the User Equipment's within the predetermined tracking area subsequent to the setting up of the MP2P EPS Bearer.

The present disclosure provides a system for creating a point to multipoint (MP2P) EPS bearer. The system provided by the present disclosure avoids usage of individual bearer systems for every User Equipment. Further, the system considers low data usage User Equipment during transmission. The MP2P EPS bearer system is powered ‘ON’ only when there is a necessity for data transmission. The MP2P EPS bearer system provides high-speed data transfer in uplink. Moreover, the MP2P EPS bearer system decouples the paging message from that of the set-up of EPS bearer.

What is claimed is:

1. A method for creating a Multipoint-to-Point (MP2P) EPS bearer in a packet switched transmission network, said method comprising the following steps:
installing a plurality of User Equipments (UE) at predetermined destinations to acquire data there from;
communicably coupling each of said User Equipments to respective radio bearers, and configuring each of said radio bearers to receive the data acquired by the User Equipments;
communicably coupling each of said radio bearers to at least one S1 bearer, and configuring said S1 bearer to multiplex acquired data received from each of the radio bearers;
communicably coupling said S1 bearer to an S5 bearer, and configuring said S5 bearer to receive the data from the S1 bearer, and further transmit received data to a database server via a public network gateway; and
wherein, said Multipoint-to-Point EPS bearer is created by a communicably coupling between said radio bearers, said S1 bearer and said S5 bearer.

2. The method as claimed in claim 1. Wherein the method farther includes the step of configuring the Multipoint-to-Point EPS bearer using an MME (Mobility Management Entity) protocol.

3. The method as claimed in claim 2, wherein the step of configuring, the Multipoint-to-Point (MP2P) EPS bearer, further includes the step of configuring the Multipoint-to-Point EPS bearer using a customized User Equipment.

4. The method as claimed in claim 1, wherein the step of creating a Multipoint-to-Point EPS bearer, further includes the step of creating and transmitting a paging message to the User Equipments within a predetermined tracking area.

5. The method as claimed in claim 1, wherein the step of configuring said S1 bearer to multiplex the data received from the radio bearers, further includes the step of configuring the S1 bearer to receive data from radio bearers present within a predetermined Tracking Area.

6. A Multipoint-to-Point (MP2P) EPS bearer, said Multipoint-to-Point EPS bearer characterized in that said EPS bearer is created by a communicably coupling between a plurality of radio bearers, at least one S1 bearer and at least one S5 bearer, and wherein:
a plurality of User Equipments (UE) are installed at predetermined destinations to acquire data there from, each of said User Equipments communicably coupled to the respective radio bearers, and said radio bearers configured to receive the data acquired by the User Equipments;
each of the radio bearers communicably coupled to the S1 bearer, said S1 bearer configured to multiplex acquired data received from each of the radio bearers; and
said S1 bearer communicably coupled to said S5 bearer, and configuring said S5 bearer to receive the data from the S1 bearer, and further transmit received data to a database server via a public network gateway.

7. The Multipoint-to-Point (MP2P) EPS bearer as claimed in claim 6, wherein the Multipoint-to-Point EPS bearer is further configured to transmit a paging message to the User Equipments within a predetermined tracking area, and trigger said User Equipments to initiate transfer of the acquired data to the Multipoint-to-Point EPS bearer.
